(19) United States
(12) Patent Application Publication
(10) Pub. No.: US 2023/0373788 A1
(43) Pub. Date: Nov. 23, 2023

(54) PURIFICATION OF BIS (FLUOROSULFONYL) IMIDE SALT

(71) Applicant: Solvay SA, Brussels (BE)

(72) Inventors: Ji Tang, Shanghai (CN); Zhengbo Zhou, Shanghai (CN); Mingxuan Chen, Shanghai (CN); Ruihua Wang, Shanghai (CN); Liping Song, Shanghai (CN)

(73) Assignee: Solvay SA, Brussels (BE)

(21) Appl. No.: 18/044,742

(22) PCT Filed: Sep. 10, 2021
(86) PCT No.: PCT/CN2021/117550

§ 371 Date: Mar. 9, 2023

(30) Foreign Application Priority Data
Sep. 10, 2020 (WO) PCT/CN2020/114436

(51) Int. Cl. C01B 21/086

(52) U.S. Cl. CPC C01B 21/086

(57) ABSTRACT

The present invention relates to a method for purifying a salt of bis (fluorosulfonyl) imide which is economically feasible at industrial scale and provides a high-purity product. Said method comprises the steps of providing a crude salt of bis (fluorosulfonyl) imide, dissolving the crude salt of bis (fluorosulfonyl) imide in at least one first solvent, crystallizing the salt of bis (fluorsulfonyl) imide by means of at least one second solvent and separating the crystallized salt of bis (fluorsulfonyl) imide, which can optionally be further reacted with an alkali salt, to obtain an alkali salt of bis (fluorosulfonyl) imide.

This application claims priority filed on 10 Sep. 2020 in INTERNATIONAL PROCEDURE with Nr CN2020/114436, the whole content of application being incorporated herein by reference for all purposes.

### TECHNICAL FIELD

The present invention relates to the purification of bis(fluorosulfonyl)imide (FSI) salt(s). More specifically, the present invention provides a new method for purifying a salt of bis(fluorosulfonyl)imide and a new method for producing alkali salts of bis(fluorosulfonyl)imide, which are economically feasible at industrial scale and which provide a high-purity product.

### BACKGROUND ART

Bis(fluorosulfonyl)imide (commonly represented by “FSIH”) and salts thereof, in particular the lithium salt of bis(fluorosulfonyl)imide (commonly represented by “LiFSI”), are useful as intermediate compound or as final compound in a variety of technical fields.

The production of bis(fluorosulfonyl)imide, the ammonium salt of bis(fluorosulfonyl)imide and the lithium salt of bis(fluorosulfonyl)imide is widely described in the literature. Among the various technologies described, the majority use a fluorination reaction either with HF or with metal fluorides, like KF, CsF, AsF₃, SbF₃, CuF₂, ZnF₂, SnF₂, PbF₂, BiF₃, etc. Other technologies have been developed, for example using chlorosulfonyl isocyanate in the presence of oleum and of ammonium fluoride or using urea and fluorosulfonic acid.

Bis(fluorosulfonyl)imide and salts thereof are especially useful in battery electrolytes. For this type of use, the presence of impurities is an important issue.

To suppress the contamination of metal impurities, the prior art document US 2013/0331609 suggests a process for producing a fluorosulfonylimide ammonium salt including reacting a chlorosulfonlyimide compound with a fluorinating agent of formula NH₄F(HF)ₚ, wherein p is 0 to 10. The thus obtained fluorosulfonylimide ammonium salt may be subjected to a cation exchange reaction to produce another fluorosulfonylimide salt. This process is said to be industrially efficient and to provide no metal impurities.

Similarly, prior art documents JP 2016-124735 and JP 2016-145147 disclose a method for producing a fluorosulfonylimide compound comprising the reaction of a chlorosulfonylimide compound with NH₄F(HF)ₚ, wherein p is 0 to 10. Said fluorosulfonylimide compound may be reacted with an alkali metal compound to produce an alkali metal salt of fluorosulfonylimide.

The prior art document EP 3381923 discloses a method for producing lithium bis(fluorosulfonyl)imide in high yield and purity, which is supposed to be simple and cost-effective. Said method consists in reacting bis(chlorosulfonyl)imide with a fluorinating reagent in a solvent, followed by treatment with an alkaline reagent, thereby producing ammonium bis(fluorosulfonyl)imide, and then reacting the ammonium bis(fluorosulfonyl)imide with a lithium base to produce lithium bis(fluorosulfonyl)imide.

The prior art document WO 2016/093399 further discloses a method for producing and purifying lithium salt of sulfonyl imide. Said method consists in reacting chlorosulfonic acid and chlorosulfonyl isocyanate to prepare chlorosulfonyl imide, then reacting said chlorosulfonyl imide with a fluorinated ammonium to prepare a fluorosulfonyl imide ammonium salt, then reacting said fluorosulfonyl imide ammonium salt with a lithium compound to obtain the lithium sulfonyl imide salt, and finally purifying said lithium sulfonyl imide salt with the help of a specific solvent.

The prior art document EP 2674395 discloses a process for producing a fluorosulfonylimide ammonium salt with good efficiency and maximum suppression of the contamination of metal impurities. Said process consists in reacting a specific chlorosulfonylimide ammonium salt with hydrogen fluoride. Then, the thus obtained fluorosulfonylimide ammonium salt can be reacted with an alkali metal compound to obtain a fluorosulfonylimide alkali metal salt.

The prior art WO 2020/099527 discloses a process for producing an alkali salt of bis(fluorosulfonyl)imide economically feasible at industrial scale and which provides a high-purity product. Said process consists in reacting bis(chlorosulfonyl)imide or salts thereof with ammonium fluoride to produce ammonium salt of bis(fluorosulfonyl)imide, crystallizing by adding at least one precipitation solvent and separating the ammonium salt of bis(fluorosulfonyl)imide and reacting the crystallized ammonium salt of bis(fluorosulfonyl)imide with an alkali salt to obtain alkali salt of bis(fluorosulfonyl)imide.

Even if these documents claim that the products are obtained with a high purity, we believe that there is still room for improvement for providing a new method for producing bis(fluorosulfonyl)imide salts which is economically feasible at industrial scale and which provides a high-purity product.

### BRIEF DESCRIPTION OF THE INVENTION

The Applicant provides hereafter a new method for purifying salt(s) of bis(fluorosulfonyl)imide and a new method for producing alkali salt(s) of bis(fluorosulfonyl)imide of high purity, at industrial scale, and with a reasonable cost when compared to the other available methods.

One subject-matter of the invention is a method for purifying a salt of bis(fluorosulfonyl)imide, comprising the steps of
(a) providing a crude salt of bis(fluorosulfonyl)imide,
(b) dissolving the crude salt of bis(fluorosulfonyl)imide in at least one first solvent selected from the group consisting of nitriles, alcohols, water, and esters,
(c) crystallizing the salt of bis(fluorsulfonyl)imide by means of at least one second solvent selected from the group consisting of cyclic and acyclic ethers, and separating the crystallized salt of bis(fluorsulfonyl)imide.

Another subject-matter of the invention is a method for producing an alkali salt of bis(fluorosulfonyl)imide, comprising the steps of
(a) providing a crude salt of bis(fluorosulfonyl)imide,
(b) dissolving the crude salt of bis(fluorosulfonyl)imide in at least one first solvent selected from the group consisting of nitriles, alcohols, water, and esters,
(c) crystallizing the salt of bis(fluorsulfonyl)imide by means of at least one second solvent selected from the group consisting of cyclic and acyclic ethers, and separating the crystallized salt of bis(fluorsulfonyl)imide,
(d) reacting the crystallized salt of bis(fluorsulfonyl)imide with an alkali salt, to obtain an alkali salt of bis(fluorosulfonyl)imide.

Still another subject-matter of the present application relates to a crystallized salt of bis(fluorosulfonyl)imide which is a solvate of the salt of bis(fluorosulfonyl)imide and a solvent selected from the group consisting of cyclic and acyclic ethers.

### DESCRIPTION OF THE INVENTION

In the present disclosure, the expression “comprised between . . . and . . . ” should be understood as including the limits. The expression “comprise” should be understood as including equally “consist of” or “consist substantively of”. If not specified otherwise, a process step is preferably carried out at room temperature and/or at atmospheric pressure. If not specified otherwise, “ppm” means parts per million in weight.

The step (a) of the method according to the invention (the method for purifying a salt of bis(fluorosulfonyl)imide, and the method for producing an alkali salt of bis(fluorosulfonyl)imide) consists in providing a crude salt of bis(fluorosulfonyl)imide.

In step (a) the crude salt of bis(fluorosulfonyl)imide is preferably provided in the solid state. It may also be provided in solution in an solvent, provided that, if this solvent is different from the first solvent which will be used in step (b), this solvent is at least partially eliminated by any method known by the skilled person, typically by evaporation, for instance by distillation. The crude salt of bis(fluorosulfonyl)imide may also be provided in step (a) in the form of a pure liquid.

The crude salt of bis(fluorosulfonyl)imide comprises 80% to 97% by weight, for example 82%, 84%, 86%, 88%, 90%, 92%, 94% or 96%, of the salt of bis(fluorosulfonyl)imide, preferably 85-95%, more preferably 90-95% by weight.

According to one embodiment, the salt of bis(fluorosulfonyl)imide provided in step (a) has the formula:

[F—SO₂—N⁻—SO₂—F] X+
wherein X represents one from the group consisting of Li, Na, K, Cs and NH₄. X can be more particularly selected from Li and NH₄. Even more particularly, X can be NH₄.

The crude salt provided in step (a) is commercially available or can be prepared according to any method known by the skilled person. According to one embodiment, it is prepared by reacting bis(chlorosulfonyl)imide or a salt thereof with a fluorination agent selected from LiF, NaF, KF, CsF, and NH₄F(HF)ₙ wherein n is 0 to 10, being preferably NH₄F(HF)ₙ wherein n is 0 to 10 and more preferably selected from NH₄F, NH₄F·HF, and NH₄F(HF)₂, optionally followed by adding at least one solvent selected from the group consisting of cyclic and acyclic ethers into the resultant reaction medium, preferably the solvent is the same with the second solvent hereinafter described.

According to another embodiment, it is prepared by reacting bis(fluorosulfonyl)imide (HFSI) with at least one alkali salt (such as a lithium, sodium, potassium, cesium or ammonium salt with an anion selected from F⁻, OH⁻, CY, SO₄²⁻, and CO₃²⁻), at a temperature between 0-100° C., in an organic solvent such as esters, ethers, nitriles, aromatic hydrocarbon—based solvents, and alcohols.

More specifically, an ammonium salt of bis(fluorosulfonyl)imide can be efficiently prepared according to the process described in WO 2020/099527, by reacting bis(chlorosulfonyl)imide or salts thereof with ammonium fluoride. This preferred embodiment will now be explained in details.

Bis(chlorosulfonyl)imide or salts thereof may be represented by the formula:

(Cl—SO₂—N⁻—SO₂—Cl) X+
wherein X represents one from the group consisting of H, Li, Na, K, Cs and NH₄.

According to a preferred embodiment, the raw material is bis(chlorosulfonyl)imide of formula (Cl—SO₂)₂—NH (commonly represented by CSIH). CSIH is commercially available, or produced by a known method, for example:
by reacting chlorosulfonyl isocyanate ClSO₂NCO with chlorosulfonic acid ClSO₂OH;
by reacting cyanogen chloride CNCl with sulfuric anhydride SO₃, and with chlorosulfonic acid ClSO₂OH;
by reacting sulfamic acid NH₂SO₂OH with thionyl chloride SOCl₂ and with chlorosulfonic acid ClSO₂OH.

According to one embodiment, in step (a), bis(chlorosulfonyl)imide or salts thereof is thus reacted with ammonium fluoride (NH₄F) as fluorinating agent to provide the crude ammonium salt of bis(fluorosulfonyl)imide. Within the present invention, the expression “ammonium fluoride” also includes HF adducts of ammonium fluoride, for example NH₄F(HF)ₙ, wherein n is 1 to 10, preferably 1 to 4, more preferably NH₄F·HF or NH₄F(HF)₂. The fluorinating agent may be commercially available, or produced by a known method.

According to a preferred embodiment, ammonium fluoride is anhydrous. Moisture content may be preferably below 5000 ppm, more preferably below 1000 ppm, even more preferably below 500 ppm.

The amount of ammonium fluoride used is preferably comprised between 1 and 10 equivalents, more preferably between 1 and 7 equivalents, and even more preferably between 2 and 5 equivalents, per 1 mol of the bis(chlorosulfonyl)imide or the salt thereof.

The reaction may be carried out preferably in an organic solvent. Said organic solvent may be selected from the aprotic organic solvents, preferably:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

According to a preferred embodiment, the organic solvent is selected from the group consisting of ethyl acetate, isopropyl acetate, butyl acetate, ethylene carbonate, dimethyl carbonate, ethyl methyl carbonate, propylene carbonate, valeronitrile and acetonitrile.

According to a preferred embodiment, the organic solvent is anhydrous. Moisture content may be preferably below 5000 ppm, more preferably below 1000 ppm, more preferably below 500 ppm, more preferably below 100 ppm even more preferably below 50 ppm.

The reaction may be carried out at a temperature of between 0° C. and 200° C., preferably, between 30° C. and 100° C. Preferably, the reaction is carried out at atmospheric pressure, but it is not excluded to work below or above atmospheric pressure, for instance between 800 mbar and 1.2 bar.

The reaction may be carried out in a batch, semi-batch or continuous mode. According to a preferred embodiment, the ammonium fluoride is first added to the organic solvent. Then, the bis(chlorosulfonyl)imide or a salt thereof may be added to the reaction medium.

By reacting bis(chlorosulfonyl)imide or salts thereof with ammonium fluoride, ammonium salt of bis(fluorosulfonyl)imide can thus be obtained. After this reaction, but before step (b), the method according to the present invention may comprise a step (a′) which consists in adding a basic compound to the reaction medium. Said basic compound may be a solid, a pure liquid, an aqueous or organic solution or a gas. Said basic compound may be selected from the group consisting of gaseous ammonia, ammonia water, amines, hydroxide, carbonates, phosphates, silicates, borates, formates, acetates, stearates, palmitates, propionates or oxalates of alkali or alkaline-earth metal. Among amines, any type of amines may be convenient, including, aliphatic amines (such as ethylamine, propylamine, butylamine, pentylamine, hexylamine, heptylamine, octylamine, dimethylamine, diethylamine, dipropylamine, dibutylamine, 2-ethylhexylamine, trimethylamine, triethylamine, tripropylamine and tributylamine), alkylenediamines (such as ethylenediamine, diethylenetriamine, triethylenetetramine, tetraethylenepentamine and pentaethylenehexamine), alkanolamines (such as monoethanolamine, diethanolamine, triethanolamine, monoisopropanolamine, diisopropanolamine and triisopropanolamine), alicyclic amines (such as cyclohexylamine and dicyclohexylamine), aromatic amines (such as benzylamine and metaxylenediamine), ethylene oxide adducts of these amines, formamidine, guanidine, amidine, and heterocyclic amines (such as diazabicycloundecene, diazabicyclononene, piperidine, morpholine, piperazine, pyrimidine, pyrrole, imidazole, imidazoline, triazole, thiazole, pyridine and indole). The basic compound used in step (a′) according to the invention is preferably gaseous ammonia or ammonia water.

The amount of basic compound added in step (a′) is preferably of between 0.1 and 10 equivalents, preferably between 0.5 and 5 equivalents, more preferably between 0.5 and 3 equivalents, based on the initial quantity of bis(chlorosulfonyl)imide or salts thereof used to prepare the ammonium salt of bis(fluorosulfonyl)imide.

During step (a′), the temperature is preferably maintained between 0° C. and 100° C., more preferably between 15° C. and 90° C. Advantageously, this step (a′) may be carried out at the same temperature as the step (a).

Optionally, the method according to the invention may comprise between step (a) and step (a′) an intermediary separation step. This intermediary separation step may be performed by any typical separation means known by the person skilled in the art, for example by filtration (for instance under pressure or under vacuum) or decantation. Alternatively or in addition, such intermediate separation step may be carried out after step (a′) and before step (b).

The step (b) of the method according to the invention consists in dissolving the crude salt of bis(fluorosulfonyl)imide in at least one first solvent selected from the group consisting of nitriles, alcohols, water and esters. The first solvent is preferably a good solvent for the salt of bis(fluorosulfonyl)imide and a poor solvent for some of the impurities (such as SO₄²⁻) in the crude salt.

Nitriles can be especially selected from alkanes or aromatic hydrocarbons substituted by at least one cyano group and having from 2 to 20 carbon atoms, in particular from 2 to 10 carbon atoms, more particularly from 2 to 7 carbon atoms. In the framework of the invention, nitriles having only one or two cyano groups are preferred. Mention can especially be made of acetonitrile, valeronitrile, adiponitrile and benzonitrile. According to one embodiment, the at least one first solvent is selected from nitriles, especially from the ones listed above and more particularly is acetonitrile.

Suitable alcohols can especially be selected from primary and secondary alcohols having at least one —OH group, having from 1 to 5 carbon atoms optionally substituted by at least one fluoro atom. In the framework of the invention, alcohols having only one —OH group are preferred. More particularly, primary alcohols, especially the fluorinated ones, are preferred. As suitable alcohols, mention can especially be made of methanol, ethanol, 1-propanol, 2-propanol, and 2,2,2,-trifluoroethanol. According to one embodiment, the at least one first solvent is selected from alcohols, especially from the ones listed above and more particularly is 2,2,2,-trifluoroethanol.

Esters can be especially selected from alkanes or aromatic hydrocarbons substituted by at least one O═C—O group and having from 2 to 20 carbon atoms, in particular from 2 to 10 carbon atoms, more particularly from 2 to 7 carbon atoms. In the framework of the invention, esters having only one or two O═C—O groups are preferred. Mention can especially be made of n-Butyl acetate and isopropyl acetate (iPAc). According to one embodiment, the at least one first solvent is selected from esters, especially from the ones listed above and more particularly is n-Butyl acetate.

The first solvent and the crude salt of bis(fluorosulfonyl)imide can be contacted in any order: by adding first the salt and then the solvent into the reactor or vice versa. In a particular embodiment, the crude salt of bis(fluorosulfonyl)imide is introduced first in the reactor and then the solvent is added therein subsequently.

To help reaching a complete dissolution, stirring can be put in place, at a stirring rate of preferably between 100-1000 rpm, more preferably between 300-500 rpm.

Alternatively or in addition, the reaction medium (consisting of the first solvent and the crude salt dissolved therein) or the solvent alone can be heated, so as to facilitate dissolution, to reach a temperature comprised between 30° C. and 80° C., in particular comprised between 40° C. and 70° C., more particularly between 50° C. and 65° C., even more particularly between 55° C. and 60° C.

In step (b), the mass ratio of the first solvent to the crude salt of bis(fluorosulfonyl)imide may range from 10:1 to 1:1, preferably from 8:1 to 1.5:1, more preferably from 6:1 to 2:1, even more preferably from 5:1 to 2:1.

Optionally, the method according to the invention may comprise between step (b) and step (c) an intermediary separation step to remove any undissolved impurities (such as a sulfate and/or a fluorosulfate). This intermediary separation step may be performed by any typical separation means known by the person skilled in the art, for example by filtration (for instance under pressure or under vacuum) or decantation.

The step (c) consists in crystallizing the salt of bis(fluorsulfonyl)imide by means of at least one second solvent selected from the group consisting of cyclic and acyclic ethers, and separating the crystallized salt of bis(fluorsulfonyl)imide. The second solvent is preferably a poor solvent for the salt of bis(fluorosulfonyl)imide and a good solvent for the impurities therein.

In the framework of the invention, cyclic and acyclic ethers have at least one ether group, preferably one or two ether group, and from 2 to 10 carbon atoms, preferably from 2 to 8 carbon atoms, more preferably from 2 to 6 carbon atoms.

As cyclic ethers, mention can especially be made of 1,3-dioxane, 4-methyl-1,3-dioxane, 1,4-dioxane, tetrahydrofuran and 2-methyltetrahydrofuran. As acyclic ethers, mention can especially be made of diethylether, diisopropylether, methyl-t-butylether, dimethoxymethane, 1,2-dimethoxyethane. More preferably, the ethers used according to the present invention are selected from diethyl ether, diisopropyl ether, methyl t-butyl ether, 1,2-dimethoxyethane, tetrahydrofuran, 2-methyltetrahydrofuran, 1,4-dioxane. According to a preferred embodiment, the second solvent is a cyclic ether. It may be more specifically chosen among the ones listed above and more preferably be 1,4-dioxane.

The crystallization of step (c) may be performed by adding the second solvent into the first solvent containing the salt of bis(fluorosulfonyl)imide dissolved therein. The addition is preferably performed dropwise. The addition may be performed in a time ranging from 1 to 20 hours, especially from 1 to 10 hours, in particular from 2 to 5 hours. After completion of the addition, the temperature may be maintained at the same value as the one set for step (b) for an additional time ranging from 1 to 20 hours, especially from 1 to 10 hours, in particular from 2 to 5 hours.

According to one embodiment, step (c) consists in adding dropwise said second solvent and optionally decreasing the temperature of the reaction medium (said reaction medium consisting of the added second solvent, the first solvent and the salt of bis(fluorosulfonyl)imide dissolved therein). This enables to foster the crystallization. The temperature of the reaction mixture containing the salt may be decreased to a value below the temperature of solubility of the salt. Preferably, the temperature is decreased to a value comprised between the solvent boiling point and −20° C., more preferably between 70° C. and −10° C., and even more preferably between 30° C. and 0° C. During the reduction of the temperature, the pressure may preferably be kept constant. However, it is not excluded to reduce the pressure simultaneously. It may cause the evaporation of a part of the organic solvent of the reaction mixture. The pressure may be decreased to a value comprised between atmospheric pressure and 10-2 mbar, preferably between 1 mbar and 500 mbar, and more preferably between 5 mbar and 100 mbar. The second solvent is preferably added first, and the temperature is decreased afterwards. However, it is not excluded to proceed the other way, or to carry out the two actions simultaneously.

According to another embodiment of the present invention, the step (c) of the method consists in adding said second solvent without decreasing the temperature of the reaction mixture containing the salt.

To facilitate mixing, stirring can be put in place, at a stirring rate of between 100-1000 rpm, preferably between 300-500 rpm. The stirring may be maintained from 2 to 24 hours afterwards, in particular from 3 to 12 hours.

In step (c) according to the invention, the mass ratio of the second solvent to the crude salt of bis(fluorosulfonyl)imide may range from 10:1 to 1:1, preferably from 8:1 to 1.5:1, more preferably from 6:1 to 2:1, even more preferably from 5:1 to 2:1.

In step (c) according to the invention, the separation of crystalized salt of bis(fluorosulfonyl)imide may be performed by any typical separation means known by the person skilled in the art, for example by filtration. Filtration may be carried out at atmospheric pressure, under pressure or under vacuum, by any means known by the person skilled in the art. Mesh size of the filtration medium may be preferably of 2 micrometer or below, more preferably of 0.45 micrometer or below, and even more preferably of 0.22 micrometer or below. A PTFE membrane can especially be used. Separated product may be washed once or several times with an appropriate solvent, preferably the same one as the first solvent, as the second solvent or a mixture of the first solvent and the second solvent. The mass ratio of the appropriate solvent to the crude salt of bis(fluorosulfonyl)imide may range from 0.1:1 to 3:1, preferably from 0.5:1 to 2.5:1, more preferably about 1:1.

The dissolution, crystallization and separation steps respectively may be carried out one time or may be repeated twice or more if necessary to improve the purity of the separated crystallized salt.

In a repeated crystallization step, the amount of the second solvent used should be reduced, taking into consideration of the amount of solvent comprised in the solvate obtained after the previous crystallization step.

Finally, the separated crystallized salt is optionally dried to obtain a purified dry product. Drying step may be carried out at a temperature in the range of 25-130° C., preferably 50-100° C., and more preferably 60-80° C. Drying step may be carried out by any means known by the person skilled in the art, typically under reduced pressure and/or by heating and/or with an inert gas flow, typically a nitrogen flow.

Advantageously, at the end of the step (c) of the method according to the invention, the salt of bis(fluorosulfonyl)imide is present in a solvate form as a solid crystal, which is advantageous since it provides a higher purity for the salt of bis(fluorosulfonyl)imide in comparison with the crude salt of bis(fluorosulfonyl)imide provided in step (a) and/or a lower moisture absorption.

The crystalized salt substantively consists of the bis(fluorosulfonyl)imide salt in the form of a solvate with the second solvent used in step (c). In the solvate, the bis(fluorosulfonyl)imide salt comprises 50-90% by weight, for example, 55%, 60%, 65%, 70%, 72%, 75%, 80%, 82% or 87% by weight, preferably 70-85% by weight, more preferably 78-83% by weight, and more preferably about 82% by weight, of the solvate, and the second solvent comprises the rest amount, for example 10-50% by weight, preferably 15-30% by weight, more preferably 17-22% by weight, and more preferably about 18% by weight, of the solvate. From a molar ratio perspective, the mole ratio of the second solvent to the bis(fluorosulfonyl)imide salt may range from 0.3:1 to 2:1, preferably from 0.4:1 to 1:1, more preferably being about 0.5:1.

Advantageously, the crystallized salt of bis(fluorosulfonyl)imide obtained at the end of step (c) of the method according to the invention has a very high purity, without consideration of the solvent comprised therein. It may show a purity of the salts above 98%, preferably above 99%, more preferably above 99.9% and most preferably between 99.9% and 100% (mass percent, without consideration of the solvent).

One object of the present application relates to the intermediate crystallized salt of bis(fluorosulfonyl)imide obtained, obtainable or able to be obtained, at the end of step (c).

Preferably, it may show the following contents of anions:
a chloride (Cl—) content of below 10 000 ppm, preferably below 5 000 ppm, more preferably below 1 000 ppm, more preferably below 500 ppm, more preferably below 100 ppm, more preferably below 50 ppm, more preferably below 20 ppm, more preferably below 5 ppm; and/or
a fluoride (F—) content of below 10 000 ppm, preferably below 5 000 ppm, more preferably below 1 000 ppm, more preferably below 500 ppm, more preferably below 100 ppm, more preferably below 50 ppm, more preferably below 25 ppm, more preferably below 20 ppm; and/or
a fluorosulfate (FSO₃⁻) content of below 5 000 ppm, preferably below 2 000 ppm, more preferably below 1 000 ppm, preferably below 500 ppm, more preferably below 100 ppm, more preferably below 50 ppm, more preferably below 25 ppm, more preferably below 10 ppm, more preferably below 5 ppm, more preferably below 1 ppm; and/or
a sulfate (SO₄²⁻) content of below 10 000 ppm, preferably below 5 000 ppm, more preferably below 1 000 ppm, more preferably below 500 ppm, more preferably below 400 ppm, more preferably below 300 ppm, more preferably below 200 ppm.

Preferably, it may show the following contents of metal elements:
an iron (Fe) content of below 1 000 ppm, preferably below 800 ppm, more preferably below 500 ppm; and/or
a chromium (Cr) content of below 1 000 ppm, preferably below 800 ppm, more preferably below 500 ppm; and/or
a nickel (Ni) content of below 1 000 ppm, preferably below 800 ppm, more preferably below 500 ppm; and/or
a zinc (Zn) content of below 1 000 ppm, preferably below 100 ppm, more preferably below 10 ppm, and/or
a copper (Cu) content of below 1 000 ppm, preferably below 100 ppm, more preferably below 10 ppm; and/or
a bismuth (Bi) content of below 1 000 ppm, preferably below 100 ppm, more preferably below 10 ppm.

Additionally, it may show:
a sodium (Na) content of below 10 000 ppm, preferably below 5 000 ppm, more preferably below 500 ppm, and/or
a potassium (K) content of below 10 000 ppm, preferably below 5 000 ppm, more preferably below 500 ppm.

In the step (d) of the present method, the crystallized salt of bis(fluorosulfonyl)imide is reengaged into a further reaction, to produce a desired alkali salt of bis(fluorosulfonyl)imide, with high purity. Indeed, the step (d) consists in reacting the crystallized salt of bis(fluorosulfonyl)imide with an alkali salt in order to obtain an alkali salt of bis(fluorosulfonyl)imide.

The crystallized salt of bis(fluorosulfonyl)imide may be used as such or solubilized in a solvent, according to the nature of the alkali salt. According to a preferred embodiment, the crystallized salt of bis(fluorosulfonyl)imide is solubilized in an organic solvent, hereafter called “alkalinization solvent”. Said alkalinization solvent may be selected from the aprotic organic solvents, preferably:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

According to a preferred embodiment, the alkalinization solvent is selected from the group consisting of ethyl acetate, isopropyl acetate, butyl acetate, ethylene carbonate, dimethyl carbonate, ethyl methyl carbonate, propylene carbonate, valeronitrile and acetonitrile.

The alkali salt may be selected from the group consisting of lithium salt, sodium salt and potassium salt. Of course, whenever the salt of bis(fluorsulfonyl)imide provided in step (a) is an alkali salt already, the cation of the alkali salt used in step (d) is different from the one of the salt of bis(fluorsulfonyl)imide provided in step (a): step (d) is a cation exchange reaction. Preferably, the alkali salt is a lithium salt, and the alkali salt of bis(fluorosulfonyl)imide obtained by the method according to the invention is lithium salt of bis(fluorosulfonyl)imide.

Examples of alkali salts include alkali hydroxide, alkali hydroxide hydrate, alkali carbonate, alkali hydrogen carbonate, alkali chloride, alkali fluoride, alkoxide compounds, alkyl alkali compounds, alkali acetate, and alkali oxalate. Preferably, alkali hydroxide or alkali hydroxide hydrate may be used in step (d). If the alkali salt is a lithium salt, then the lithium salt may be selected from the group consisting of lithium hydroxide LiGH, lithium hydroxide hydrate LiOH·H₂O, lithium carbonate Li₂CO₃, lithium hydrogen carbonate LiHCO₃, lithium chloride LiCl, lithium fluoride LiF, alkoxide compounds such as CH₃OLi and EtOLi, alkyl lithium compounds such as EtLi, BuLi and t-BuLi, lithium acetate CH₃COOLi, and lithium oxalate Li₂C₂O₄. Preferably, lithium hydroxide LiOH or lithium hydroxide hydrate LiOH·H₂O may be used in step (d).

Said alkali salt may be added in step (d) as a solid, as a pure liquid or as an aqueous or organic solution.

The amount of alkali salt used is preferably comprised between 0.5 and 5 mol, more preferably between 0.9 and 2 mol, and even more preferably between 1 and 1.5 mol, per 1 mol of the salt of bis(fluorosulfonyl)imide.

The reaction may be carried out at a temperature of between 0° C. and 50° C., more preferably between 15° C. and 35° C., and even more preferably at about the room temperature. Preferably, the reaction is carried out at atmospheric pressure, but it is not excluded to work below or above atmospheric pressure, for instance between 5 mbar and 1.5 bar, preferably between 5 mbar and 100 mbar.

Further treatments may be carried out in order to recover very pure alkali salt of bis(fluorosulfonyl)imide. The reaction medium may be a biphasic (aqueous/organic) solution, especially when the alkali salt used in step (d) is an aqueous solution. In this case, the method may comprise a phase separation step, during which the aqueous phase is removed and the alkali salt of bis(fluorosulfonyl)imide is recovered in the organic phase. Additional steps may comprise filtration, concentration, extraction, recrystallization, purification by chromatography, drying and/or formulation.

Generally speaking, all raw materials used in the method according to the invention, including solvents, reagents, etc., may preferably show very high purity criteria. Preferably, their content of metal components such as Na, K, Ca, Mg, Fe, Cu, Cr, Ni, Zn, is below 10 ppm, more preferably below 2 ppm.

Advantageously, the alkali salt of bis(fluorosulfonyl)imide obtained by the method according to the invention has a very high purity. It may show a purity of alkali salts above 90%, preferably above 95%, more preferably above 98%, even more preferably above 99% and most preferably between 99.9% and 100%.

Preferably, it may show the following contents of anions:
a chloride (Cl—) content of below 10 000 ppm, preferably below 5 000 ppm, more preferably below 1 000 ppm, more preferably below 500 ppm, more preferably below 100 ppm, more preferably below 50 ppm, more preferably below 20 ppm, more preferably below 5 ppm; and/or
a fluoride (F—) content of below 10 000 ppm, preferably below 5 000 ppm, more preferably below 1 000 ppm, more preferably below 500 ppm, more preferably below 100 ppm, more preferably below 50 ppm, more preferably below 25 ppm, more preferably below 20 ppm; and/or
a fluorosulfate (FSO₃⁻) content of below 5 000 ppm, preferably below 2 000 ppm, more preferably below 1 000 ppm, preferably below 500 ppm, more preferably below 100 ppm, more preferably below 50 ppm, more preferably below 25 ppm, more preferably below 10 ppm, more preferably below 5 ppm, more preferably below 1 ppm; and/or
a sulfate (SO₄²⁻) content of below 10 000 ppm, preferably below 5 000 ppm, more preferably below 1 000 ppm, more preferably below 500 ppm, more preferably below 400 ppm, more preferably below 300 ppm, more preferably below 200 ppm.

Preferably, it may show the following contents of metal elements:
an iron (Fe) content of below 1 000 ppm, preferably below 800 ppm, more preferably below 500 ppm; and/or
a chromium (Cr) content of below 1 000 ppm, preferably below 800 ppm, more preferably below 500 ppm; and/or
a nickel (Ni) content of below 1 000 ppm, preferably below 800 ppm, more preferably below 500 ppm; and/or
a zinc (Zn) content of below 1 000 ppm, preferably below 100 ppm, more preferably below 10 ppm, and/or
a copper (Cu) content of below 1 000 ppm, preferably below 100 ppm, more preferably below 10 ppm; and/or
a bismuth (Bi) content of below 1 000 ppm, preferably below 100 ppm, more preferably below 10 ppm.

Additionally, when the alkali salt of bis(fluorosulfonyl)imide is not sodium bis(fluorosulfonyl)imide, it may show:
a sodium (Na) content of below 10 000 ppm, preferably below 5 000 ppm, more preferably below 500 ppm.

Additionally, when the alkali salt of bis(fluorosulfonyl)imide is not potassium bis(fluorosulfonyl)imide, it may show:
a potassium (K) content of below 10 000 ppm, preferably below 5 000 ppm, more preferably below 500 ppm.

Thanks to its very high purity, the alkali salt of bis(fluorosulfonyl)imide, and preferably the lithium bis(fluorosulfonyl)imide, obtainable by the method according to the invention, may be advantageously used in electrolyte compositions for batteries.

Should the disclosure of any patents, patent applications, and publications which are incorporated herein by reference conflict with the description of the present application to the extent that it may render a term unclear, the present description shall take precedence.

The invention will now be further described in examples in connection with figures. The examples are given by way of illustration and which are not intended to limit the specification or the claims in any manner.

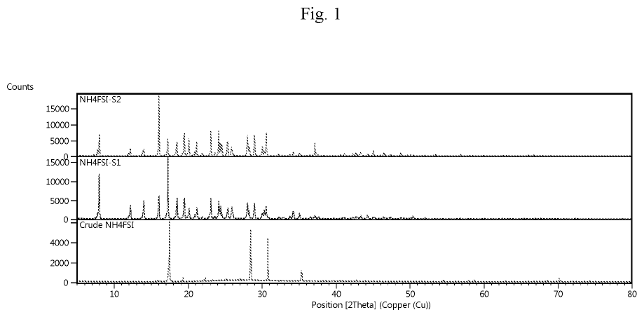

FIG. 1 shows the XRD spectrums of crude NH₄FSI and the product NH₄FSI solvates, which confirm the production of the NH₄FSI solvate crystals.

The following equipments are used in the examples: a 3-neck flask, having a capacity of 2000 ml, equipped with a PTFE anchor impeller, an overhead stirrer (maximum speed of 1500 rpm), a glass reflux condenser, a heating plate (silicon oil: max 160° C.), a 0.22 μm PTFE membrane filter with a glass filter funnel; a buchi rotary evaporator, with a vacuum pump (PC3001 VARIOpro), and a maximum pumping speed of 33 L/min.

### Example 1

The process has been carried out in a 500 mL reactor under N₂ with stirring means, a double jacket for thermal regulation, a condenser, a pressure regulator means and a liquid or gas addition means. At room temperature, 400 g of ethyl methyl carbonate were introduced, and 81 g of anhydrous NH₄F was suspended. 77 g of molten CSIH was added gradually during 1 hour, and the mixture was heated at 80° C. under stirring during 15 hours. It was cooled to room temperature and 25 g of NH₄OH (aq) (ammonia water) was added. The obtained mixture was stirred at room temperature for 1 h and then filtered.

332 g of the obtained product was concentrated to 48 g. 300 g TFE was added into the solution and concentrated to 170 g solution, this operation was repeated twice. The 170 g solution was transferred into the 3-necked flask. The overhead stirrer was set at 500 rpm. The temperature of the solution was set to 60° C. to ensure a complete dissolution of NH4FSI in TFE. Then, 139.5 g of 1,4-dioxane was added dropwise to the reactor in 3 h. After completion of the 1,4-dioxane addition, the solution temperature was kept at 60° C. for another period of 2 h. The contents inside the flask was naturally cooled down to room temperature in about 2 h, and the stirring was maintained overnight for about 12 hours. The contents inside the flask was filtrated using a 0.22 μm PTFE membrane to collect the solid NH₄FSI. The collected solid cake was washed with 60 g of 1,4-dioxane. The collected solid was dried using the rotary evaporator under 70° C. at 20 mbar until there was no more solvent evaporation to afford 28.8 g of a white solid. Yield is 78.2%.

### Example 2

Into the 3-necked flask, 148 g of crude ammonium bis(fluorosulfonyl)imide (NH₄FSI) obtained at the end of part II, example 1 of WO 2020/099527 is added; 666 g of 2,2,2-trifluoroethanol (TFE) is added subsequently. The overhead stirrer is set at 350 rpm. The temperature of the solution is set to 60° C. to ensure a complete dissolution of NH₄FSI in TFE. Then, 666 g of 1,4-dioxane is added dropwise to the reactor in 3 h. After completion of the 1,4-dioxane addition, the solution temperature is kept at 60° C. for another period of 3 h. The contents inside the flask is naturally cooled down to room temperature in about 3 h, and the stirring is maintained overnight for about 12 hours. The contents inside the flask is filtrated using a 0.22 μm PTFE membrane to collect the solid NH₄FSI. The collected solid cake is washed with 300.5 g of 1,4-dioxane. The 357.7 g of the collected wet solid is dried using the rotary evaporator under 70° C. at 20 mbar until there is no more solvent evaporation to afford 166.6 g of a white solid, being a crystalized solvate of NH₄FSI (denoted as NH₄FSI—S1, see FIG. 1 for its XRD spectrum) comprising 80.5 wt % NH₄FSI and 19.5 wt % 1,4-dioxane, as confirmed by ¹⁹F-NMR (Bruker Avance 300 NMR). The recrystallization yield, as calculated by the following formula, is 90.6%.

$$Yield = \frac{weight ( NH 4 FSI in NH 4 FSI - S 1 )}{weight ( Crude NH 4 FSI )}$$

The process is carried out a second time on 161.3 g of the product recovered from the first time, by means of the following amounts of chemicals: 585.2 g of TFE, 555.4 g of 1,4 dioxane for the crystallization and 300.1 g of 1,4 dioxane for the washing. After drying, 152.0 g of a white solid is obtained, being a crystalized solvate of NH₄FSI (denoted as NH₄FSI—S2, see FIG. 1 for its XRD spectrum) comprising 79.9 wt % NH₄FSI and 20.1 wt % 1,4-dioxane, as confirmed by ¹⁹F-NMR (Bruker Avance 300 NMR). The recrystallization yield, as calculated by the following formula, is 93.5%.

$$Yield = \frac{weight ( NH 4 FSI in NH 4 FSI - S 2 )}{weight ( NH 4 FSI in NH 4 FSI - S 1 )}$$

The following table 1 shows the Ion Chromatography (DIONEX ICS-3000) results of the crude NH₄FSI and the product NH₄FSI solvates obtained after the first recrystallization and the second recrystallization.

TABLE 1
IC results of crude NH₄FSI and product NH₄FSI solvates

| Sample | F⁻ (ppm) | Cl⁻ (ppm) | SO₄²⁻ (ppm) | FSO₃⁻ (ppm) |
|---|---|---|---|---|
| Crude NH₄FSI | 1762 | 118 | 274 | 2341 |
| NH₄FSI-S1 | 23 | 4 | 390 | 27 |
| NH₄FSI-S2 | 17 | Not Detected | 291 | Not Detected |

### Example 3

152.0 g of the dried solid obtained form Example 2 was solubilized in 500 g butyl acetate. 113.2 g of a 25 wt % aqueous solution of LiOH·H2O (i.e., 28.3 g of LiOH·H2O) was added. The obtained biphasic mixture was stirred during 5 hours at room temperature, and then decanted. The organic phase was recovered and put into a thin film evaporator at 60° C. under reduced pressure (0.1 bar). The purity of the obtained lithium bis(flurosulfonyl)imide (LiFSI) was above 99.99 wt %, chlorine and fluorine contents were below 20 ppm, and mental elements contents were below 5 ppm, with no other impurities such as SO₄²⁻ and FSO₃⁻ detected.

### Example 4

The second recrystallization process of example 2 was repeated on the LiFSI solid obtained from example 3 to produce a crystalized solvate of LiFSI comprising 80% of LiFSI and 20% of 1,4-dioxane, by weight.

100 g of the LiFSI/dioxane solvate produced was added into 700 g of EMC (ethyl methyl carbonate). The resulting solution was fed into a flask with a fine distillation column, a condenser and a distillate receiver. The solution inside the flask was heated to 25-30° C. under a reduced pressure of 20 mbar, the reflux ratio was set to 5:1.

The LiFSI solution was concentrated by fine distillation and the dioxane content in the distillate was less than 100 ppm while the content of LiFSI was 30%, relative to the total weight of the distillate.

1. A method for purifying a salt of bis(fluorosulfonyl)imide, comprising the steps of:
(a) providing a crude salt of bis(fluorosulfonyl)imide,
(b) dissolving the crude salt of bis(fluorosulfonyl)imide in at least one first solvent selected from the group consisting of nitriles, alcohols, water, and esters,
(c) crystallizing the salt of bis(fluorsulfonyl)imide by means of at least one second solvent selected from the group consisting of cyclic and acyclic ethers, and separating the crystallized salt of bis(fluorsulfonyl)imide.

2. The method for producing an alkali salt of bis(fluorosulfonyl)imide, comprising the steps of:
(a) providing a crude salt of bis(fluorosulfonyl)imide,
(b) dissolving the crude salt of bis(fluorosulfonyl)imide in at least one first solvent selected from the group consisting of nitriles, alcohols, water and esters,
(c) crystallizing the salt of bis(fluorsulfonyl)imide by means of at least one second solvent selected from the group consisting of cyclic and acyclic ethers, and separating the crystallized salt of bis(fluorsulfonyl)imide,
(d) reacting the crystallized salt of bis(fluorsulfonyl)imide with an alkali salt, to obtain an alkali salt of bis(fluorosulfonyl)imide.

3. The method according to claim 1 wherein the crude salt of bis(fluorosulfonyl)imide provided in step (a) comprises 80% to 97% by weight of the salt of bis(fluorosulfonyl)imide.

4. The method according to claim 1 wherein the salt of bis(fluorosulfonyl)imide has the formula:
[F—SO₂—N⁻—SO₂—F] X+
wherein X represents one from the group consisting of Li, Na, K, Cs and NH₄.

5. The method according to claim 1, wherein step (a) consists in reacting bis(chlorosulfonyl)imide or a salt thereof with a fluorination agent selected from LiF, NaF, KF, CsF, and NH₄F(HF)ₙ wherein n is 0 to 10, and optionally adding into the resultant reaction medium at least one solvent selected from the group consisting of cyclic and acyclic ethers.

6. The method according to claim 1, wherein the mass ratio of the first solvent to the crude salt of bis(fluorosulfonyl)imide ranges from 10:1 to 1:1.

7. The method according to claim 1, wherein in step (b), the first solvent is selected from: acetonitrile, valeronitrile, adiponitrile, benzonitrile; methanol, ethanol, 1-propanol, 2-propanol, 2,2,2,-trifluoroethanol; n-Butyl acetate and isopropyl acetate.

8. The method according to claim 1, wherein step (c) consists in adding dropwise the second solvent and optionally decreasing the temperature of the reaction medium.

9. The method according to claim 1, wherein in step (c), the second solvent is selected from: diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, and 1,4-dioxane.

10. The method according to claim 1, wherein the mass ratio of the second solvent to the crude salt of bis(fluorosulfonyl)imide ranges from 10:1 to 1:1.

11. The method according to claim 1, wherein the separated crystallized salt of bis(fluorsulfonyl)imide is washed and/or dried at the end of step (c).

12. The method according to claim 2, wherein in step (d), the alkali salt is selected from the group consisting of lithium salt, sodium salt and potassium salt, being preferably a lithium salt.

13. A crystallized salt of bis(fluorosulfonyl)imide with the formula:
[F—SO₂—N⁻—SO₂—F] X+
wherein X represents one from the group consisting of Li, Na, K, Cs and NH₄,
which is a solvate comprising 50-90% by weight, of the salt of bis(fluorosulfonyl)imide, and 10-50% by weight, of a solvent selected from the group consisting of cyclic and acyclic ethers.

14. The crystallized salt of bis(fluorosulfonyl)imide according to claim 13, which is obtained by crystallizing the salt of bis(fluorsulfonyl)imide by means of at least one second solvent selected from the group consisting of cyclic and acyclic ethers, and separating the crystallized salt of bis(fluorsulfonyl)imide.

15. The crystallized salt of bis(fluorosulfonyl)imide according to claim 13, showing the following contents:
a chloride (Cl—) content of below 10 000 ppm; and/or
a fluoride (F—) content of below 10 000 ppm; and/or
a fluorosulfate (FSO₃⁻) content of below 5 000 ppm, ppm; and/or
a sulfate (SO₄²⁻) content of below 10 000 ppm, and/or
an iron (Fe) content of below 1 000 ppm; and/or
a chromium (Cr) content of below 1 000 ppm; and/or
a nickel (Ni) content of below 1 000 ppm; and/or
a zinc (Zn) content of below 1 000 ppm, and/or
a copper (Cu) content of below 1 000 ppm; and/or
a bismuth (Bi) content of below 1 000 ppm; and/or
a sodium (Na) content of below 10 000 ppm, and/or
a potassium (K) content of below 10 000 ppm.
